(19) United States
(12) Patent Application Publication
(10) Pub. No.: US 2025/0109801 A1
(43) Pub. Date: Apr. 3, 2025

(54) COUPLED VALVE ASSEMBLY

(71) Applicant: OIL STATES INDUSTRIES, INC., Arlington, TX (US)

(72) Inventors: Barrett Reid Hartman, Choctaw, OK (US); Thomas Dale Clay, Edmond, OK (US)

(73) Assignee: OIL STATES INDUSTRIES, INC., Arlington, TX (US)

(21) Appl. No.: 18/888,984

(22) Filed: Sep. 18, 2024

Related U.S. Application Data
(60) Provisional application No. 63/586,156, filed on Sep. 28, 2023.

(51) Int. Cl. F16K 31/02; F16K 21/08; F16K 31/44

(52) U.S. Cl. CPC F16K 31/02; F16K 21/08; F16K 31/44

(57) ABSTRACT

A coupled valve assembly comprises two valves disposed within separate housings and connected with a common coupling, such that a single actuator causes rotation of the valve stems within both valves. The two valves are configured 90 degrees out of phase with each other, such that the actuator will cause one valve to open at the same time it causes the other valve to close. The coupled valve assembly may be used to selectively divert the flow of production fluids from a wellbore to either a production header or a test header within a production manifold.

### TECHNICAL FIELD

The present disclosure relates generally to oil or gas wellbore equipment, and, more particularly, to a coupled valve assembly.

### BACKGROUND

Once an oil & gas wellbore is completed and the operator of the well is ready to begin extracting hydrocarbon resources from the formation surrounding the wellbore, the operator will move into the production phase. With the multi-well configurations that are currently common in the industry, production operations at a single wellsite often involve numerous wells producing fluids comprising natural gas, oil and water individually, simultaneously, or collectively. When multiple wells are producing at the same wellsite, the fluids are often transported to a central collection or gathering station. In addition to collecting production fluids for further processing or transportation, the fluids must generally be periodically tested to ensure the quality of the fluids produced. Accordingly, the production of each well is generally directed to a common manifold system that communicates the produced fluids to various testing and/or production destinations. A multi-well production manifold comprises an inlet from each individual well, a production header through which fluids are transported to the central collection station, and a test header through which fluids are transported to a separate location for testing. The system must also include a device capable of selectively routing the fluids from each individual inlet to either the production header or the test header.

Operators have traditionally utilized a variety of devices and methods to divert flow from each individual inlet to either the production header or the test header of the production manifold. A multiport selector valve is one such device. An example of a multiport selector valve is disclosed in U.S. Pat. No. 7,343,933, “Multi-port flow selector manifold valve and manifold system,” issued to McBeth, et al. These systems, however, are large and heavy, and require a complex and expensive actuator.

Another approach used by some operators is multiple valves for each inlet, with a separate actuator for each individual valve. For example, a first ball valve may be located between the inlet and the production header, with a first actuator capable of regulating the flow of produced fluid to the production header. In addition, a second ball valve may be located between the inlet and the test header, with a second actuator capable of regulating the flow of produced fluid to the test header. This arrangement, however, is expensive and complex due to the need for multiple actuators.

Accordingly, what is needed is a control system allowing an operator to selectively route produced fluids to either portion of the production manifold (i.e., to either the production header or the test header), while addressing the above-described drawbacks of existing systems, among one or more other issues.

### SUMMARY OF THE INVENTION

The coupled valve assembly uses two or more valves, each in a separate housing but connected to a single actuator via a common coupling attached to the stem of each valve. The valves are 90 degrees out of phase, such that a turn of the single actuator will simultaneously close one valve and open the other valve. In this way, the overall control system is simplified and the expense is significantly decreased, as compared to a multiport selector valve or a system with multiple independent actuators.

In an embodiment, the actuator comprises a manual actuator.

In an embodiment, the actuator comprises an electric actuator.

In an embodiment, the actuator comprises a hydraulic actuator.

In an embodiment, the actuator comprises a pneumatic actuator.

In an embodiment, the coupled valve assembly may further comprise a second coupling comprising an upper end and a lower end, wherein the upper end is operatively connected to a lower valve stem of the second valve, and a third valve comprising a throughbore, a valve stem operatively coupled to the lower end of the second coupling, and a flow barrier configured to selectively obstruct the flow of fluid through the throughbore.

### BRIEF DESCRIPTION OF THE DRAWINGS

Various embodiments of the present disclosure will be understood more fully from the detailed description given below and from the accompanying drawings of various embodiments of the disclosure. In the drawings, like reference numbers may indicate identical or functionally similar elements.

FIG. 1 illustrates a perspective view of a production manifold incorporating one embodiment of the coupled valve assembly.

FIG. 2 illustrates a cross-sectional view of one portion of the production manifold shown in FIG. 1, with a single coupled valve assembly.

### DETAILED DESCRIPTION

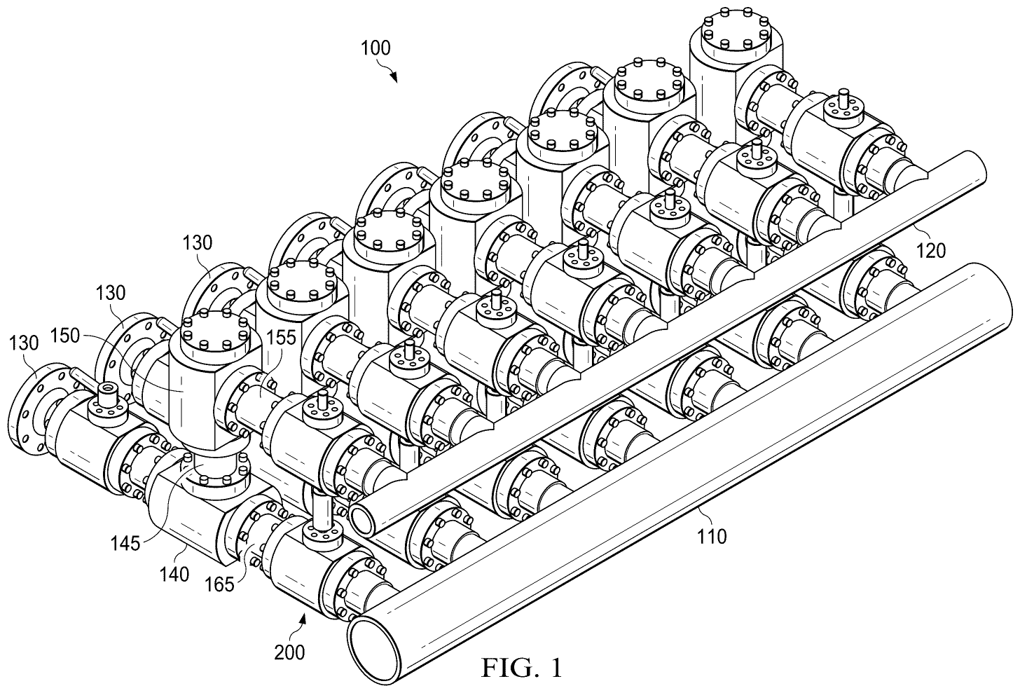

FIG. 1 illustrates a production manifold 100 incorporating one embodiment of a coupled valve assembly 200. Production manifold 100 comprises an inlet 130 for each well that is part of the overall production system at a given portion of the wellsite. Production manifold 100 also comprises a production header 110, which is connected to a central collection or gathering station (not shown) and a test header 120, which is connected to a separate device or system (not shown) capable of testing certain qualities or characteristics of the produced fluids.

Each inlet 130 is connected on one side to a well (not shown) through which fluids are produced from the formation surrounding a wellbore. Fluid passing through inlet 130 flows to connection block 140 and, from there, in one of two directions. The fluid may flow through connecting spool 145, to connection block 150, through connecting spool 155, and to test header 120. Alternatively, the fluid may flow through connecting spool 165 and to production header 110. Accordingly, each inlet 130 requires some means to divert the produced fluids to either production header 110 or test header 120, depending on the particular production methodology being employed by the operator.

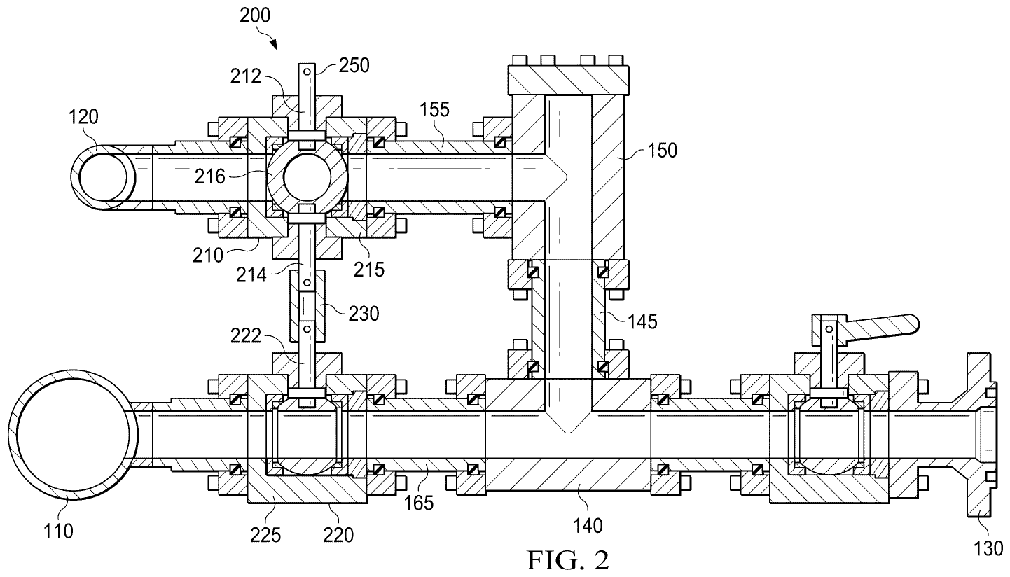

FIG. 2 illustrates a cross-sectional view of one portion of production manifold 100 shown in FIG. 1, with a single coupled valve assembly 200. In this embodiment, coupled valve assembly 200 comprises first ball valve 210 and second ball valve 220. First ball valve 210 is disposed within housing 215. Second ball valve 220 is disposed within housing 225. Housing 215 and housing 225 are physically separate, as shown in FIG. 2. This aspect of the present embodiment allows greater flexibility, as compared to including both ball valves within a common housing. For example, the distance between the ball valves may be adjusted to accommodate differences in the distance between the test header and the production header in particular production manifolds.

First ball valve 210 is connected to connecting spool 155 and comprises housing 215, upper stem 212, lower stem 214, and ball 216. Upper stem 212 is operatively attached to actuator 250. Actuator 250 may be any type of known actuating device, including but not limited to a manual, electric, hydraulic, or pneumatic actuator. As one of ordinary skill in the art will readily understand, actuator 250 is configured to rotate upper stem 212, which in turn causes the rotation of ball 216. Ball 216 will either permit fluid to flow through connecting spool 155 to test header 120, or it will obstruct fluid flow through connecting spool 155. In the exemplary state shown in FIG. 2, ball 216 is rotated to the position that obstructs flow through connecting spool 155. Accordingly, in this position, no fluid will flow from inlet 130 to test header 120. Ball 216 is also connected to lower stem 214, which is in turn connected to coupling 230.

Second ball valve 220 is connected to connecting spool 165 and comprises housing 225 and stem 222. Ball valve 220 also comprises a ball that is not shown in the view illustrated in FIG. 2. The ball of ball valve 220 operates similar to ball 216 of first ball valve 210, although the two valves are 90 degrees out of phase with each other. Accordingly, as shown in FIG. 2, when first ball valve 210 is closed, second ball valve 220 is open and fluid is allowed to flow from connection block 140, through connecting spool 165, through second ball valve 220, and to production header 110.

Stem 222 of second ball valve 220 is also operatively connected to coupling 230. Accordingly, upper stem 212 of first ball valve 210, lower stem 214 of first ball valve 210, and stem 222 of second ball valve 220 operate as a unitary drive train for coupled ball valve assembly 200. Thus, when actuator 250 causes the rotation of upper stem 212, it will simultaneously cause the rotation of ball 216, lower stem 214, coupling 230, stem 222, and the ball disposed within housing 225 of second ball valve 220.

Although coupled ball valve assembly 200 is shown comprising two ball valves, this design would allow the use of three of more ball valves in a single assembly. In addition, because each ball valve is disposed within its own separate housing, adding another valve to an existing assembly would be relatively straightforward.

Although the specific embodiments disclosed herein comprise ball valves, the present invention is not limited to any particular type of flow barrier. As one of ordinary skill in the art will understand, the concept disclosed herein is potentially applicable to other types of valves, including but not limited to other quarter-turn valves such a plug valve or butterfly valve.

It is understood that variations may be made in the foregoing without departing from the scope of the present disclosure. In several exemplary embodiments, the elements and teachings of the various illustrative exemplary embodiments may be combined in whole or in part in some or all of the illustrative exemplary embodiments. In addition, one or more of the elements and teachings of the various illustrative exemplary embodiments may be omitted, at least in part, and/or combined, at least in part, with one or more of the other elements and teachings of the various illustrative embodiments.

Any spatial references, such as, for example, “upper,” “lower,” “above,” “below,” “between,” “bottom,” “vertical,” “horizontal,” “angular,” “upwards,” “downwards,” “side-to-side,” “left-to-right,” “right-to-left,” “top-to-bottom,” “bottom-to-top,” “top,” “bottom,” “bottom-up,” “top-down,” etc., are for the purpose of illustration only and do not limit the specific orientation or location of the structure described above. Similarly, references to the general shape of certain components, such as for example, “planar” or “cylindrical,” are for the purpose of illustration only and do not limit the specific configuration of the structure described above.

In several exemplary embodiments, while different steps, processes, and procedures are described as appearing as distinct acts, one or more of the steps, one or more of the processes, and/or one or more of the procedures may also be performed in different orders, simultaneously and/or sequentially. In several exemplary embodiments, the steps, processes, and/or procedures may be merged into one or more steps, processes and/or procedures.

In several exemplary embodiments, one or more of the operational steps in each embodiment may be omitted. Moreover, in some instances, some features of the present disclosure may be employed without a corresponding use of the other features. Moreover, one or more of the above-described embodiments and/or variations may be combined in whole or in part with any one or more of the other above-described embodiments and/or variations.

Although several exemplary embodiments have been described in detail above, the embodiments described are exemplary only and are not limiting, and those skilled in the art will readily appreciate that many other modifications, changes and/or substitutions are possible in the exemplary embodiments without materially departing from the novel teachings and advantages of the present disclosure. Accordingly, all such modifications, changes, and/or substitutions are intended to be included within the scope of this disclosure as defined in the following claims. In the claims, any means-plus-function clauses are intended to cover the structures described herein as performing the recited function and not only structural equivalents, but also equivalent structures. Moreover, it is the express intention of the applicant not to invoke 35 U.S.C. § 112,paragraph 6 for any limitations of any of the claims herein, except for those in which the claim expressly uses the word “means” together with an associated function.

1. A coupled valve assembly comprising:
an actuator;
a first valve comprising:
a throughbore;
an upper valve stem operatively connected to the actuator;
a flow barrier configured to selectively obstruct the flow of fluid through the throughbore; and
a lower valve stem;
a first coupling comprising an upper end and a lower end, wherein the upper end is operatively connected to the lower valve stem of the first valve; and
a second valve comprising:
a throughbore;
an upper valve stem operatively connected to the lower end of the first coupling; and
a flow barrier configured to selectively obstruct the flow of fluid through the throughbore;
wherein the assembly is configured such that, in a first position, the throughbore of the first valve is substantially obstructed and the throughbore of the second valve is substantially unobstructed and, in a second position, the throughbore of the first valve is substantially unobstructed and the throughbore of the second valve is substantially obstructed.

2. The coupled valve assembly of claim 1, wherein the flow barrier of the first valve comprises a ball.

3. The coupled valve assembly of claim 2, wherein the flow barrier of the second valve comprises a ball.

4. The coupled valve assembly of claim 1, wherein the actuator comprises a manual actuator.

5. The coupled valve assembly of claim 1, wherein the actuator comprises an electric actuator.

6. The coupled valve assembly of claim 1, wherein the actuator comprises a hydraulic actuator.

7. The coupled valve assembly of claim 1, wherein the actuator comprises a pneumatic actuator.

8. The coupled valve assembly of claim 1, further comprising:
a second coupling comprising an upper end and a lower end, wherein the upper end is operatively connected to a lower valve stem of the second valve; and
a third valve comprising:
a throughbore;
a valve stem operatively connected to the lower end of the second coupling; and
a flow barrier configured to selectively obstruct the flow of fluid through the throughbore.

9. The coupled valve assembly of claim 8, wherein the flow barrier of the third valve comprises a ball.

10. The coupled valve assembly of claim 8, wherein the assembly is configured such that:
in a first position, the throughbore of the first valve and the throughbore of the second valve are substantially obstructed and the throughbore of the third valve is substantially unobstructed; and
in a second position, the throughbore of the first valve and the throughbore of the second valve are substantially unobstructed and the throughbore of the third valve is substantially obstructed.

11. The coupled valve assembly of claim 8, wherein the assembly is configured such that:
in a first position, the throughbore of the first valve and the throughbore of the third valve are substantially obstructed and the throughbore of the second valve is substantially unobstructed; and
in a second position, the throughbore of the first valve and the throughbore of the third valve are substantially unobstructed and the throughbore of the second valve is substantially obstructed.

12. The coupled valve assembly of claim 8, wherein the assembly is configured such that:
in a first position, the throughbore of the second valve and the throughbore of the third valve are substantially obstructed and the throughbore of the first valve is substantially unobstructed; and
in a second position, the throughbore of the second valve and the throughbore of the third valve are substantially unobstructed and the throughbore of the first valve is substantially obstructed.

13. A method of directing fluid from a wellhead to a manifold, comprising the following steps:
actuating an actuator to open a first valve, allowing fluid to flow from the wellhead, through the first valve, and into a test header of a production manifold; and
actuating the actuator to close the first valve and open a second valve, allowing fluid to flow from the wellhead, through the second valve, and into a production header of the production manifold.

14. The method of claim 13, wherein the first valve comprises a ball valve.

15. The method of claim 13, wherein the second valve comprises a ball valve.

16. The method of claim 10, wherein the actuator comprises a manual actuator.

17. The method of claim 10, wherein the actuator comprises an electric actuator.

18. The method of claim 10, wherein the actuator comprises a hydraulic actuator.

19. The method of claim 10, wherein the actuator comprises a pneumatic actuator.
